(19) United States
(12) Patent Application Publication
(10) Pub. No.: US 2007/0220132 A1
(43) Pub. Date: Sep. 20, 2007

(54) Server device and communication system

(75) Inventor: Yoshifumi Tanimoto, Fushimi-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/717,203

(22) Filed: Mar. 13, 2007

(30) Foreign Application Priority Data
Mar. 20, 2006 (JP) 2006-077191

(51) Int. Cl. G06F 15/173

(52) U.S. Cl. 709/223; 709/225

(57) ABSTRACT

A data management device is provided in a Local Area Network inside a firewall, and a server is provided in a Wide Area Network outside the firewall. When the data management device carries out a TCP connection request to the server and a TCP connection is established, the data management device transmits index information to the server. The established TCP connection is held. The client device acquires the index information from the server, and carries out a file access request to the server according to the index information. The server uses the held TCP connection to acquire a file from the data management device, and transmits the file to the client device.

### BACKGROUND OF THE INVENTION

1. Field of the Invention

The present invention relates to technology for sharing data by using a network.

2. Description of the Related Art

There are various communication systems using a server connected to a network. For example, a client device and a data server are connected via the network. The client device accesses data stored in the data server, and executes various applications.

When the client device and the data server are located within the same network, necessity for securing the server is not particularly high. For example, in a system in which personal computers (PCs) of employees are connected to a data server provided in a Local Area Network (LAN) of an office, there is normally no problem for the data server to accept a connection request from the PCs.

However, circumstance is different for a server connected to a public network such as the Internet. The server is generally provided in a private network such as the LAN, and a firewall is provided between the server and the Internet. A free access to the server from the outside is prohibited to maintain security of a network or the like in an office.

A conventional network system uses a plurality of business servers. A gateway server receives a login request from a user for once. The gateway server decides a business server to be connected according to contents of the login request. Then, the gateway server establishes a connection with the business server.

As described above, to publicize the server provided in a private network, a firewall is generally provided between the server and the public network. However, to permit a connection to be established from the outside to the server, a prescribed port is required to be provided available at the firewall. Thus, there is a problem that the security level decreases.

According to a conventional method, a gateway is provided between a client device and a server. However, a connection is required to be established from the gateway server to the business server. Therefore, when the business server is located inside the firewall, a connection request is required to be transmitted from the outside network into the private network, and to pass through the firewall.

In a system in which a client device is directly connected to a data server, when an environment of the data server connected to a network changes, the client device is also required to change a setting. Thus, management load is not small.

### SUMMARY OF THE INVENTION

In order to overcome the problems described above, preferred embodiments of the present invention construct a system which permits a client device to access a server connected to a network while highly maintaining security level.

According to an aspect of the present invention, a server device includes an index information receiving unit, an index information transmitting unit, and a data transmitting unit. The index information receiving unit accepts a Transmission Control Protocol (TCP) connection request from a data management device, holds a TCP connection, and receives index information of data managed by the data management device by using the held TCP connection. The index information transmitting unit transmits the index information to a client device. When receiving an access request from the client device according to the index information for accessing data managed by the data management device, the data transmitting unit acquires designated data from the data management device using the held TCP connection, and transmits the acquired data to the client device.

According to another aspect of the present invention, the server device also includes an authentication unit that authenticates an access request made by the client device.

According to another aspect of the present invention, the server device includes an index information receiving unit, a setting unit, and an index information transmitting unit. The index information receiving unit holds a TCP connection with a plurality of data management devices, and receives index information from the plurality of the data management devices. The setting unit sets an access right of the client device with respect to each of the data management devices or a group of the data management devices. The index information transmitting unit transmits the index information of the data management device, of which an access right is given to the client device, to the client device.

According to another aspect of the present invention, a communication system includes a data management device, a server device, and a client terminal. The data management device includes a data storing and managing unit, and a connection requesting unit that requests a TCP connection to the server device. The server device includes an index information receiving unit, and an index information transmitting unit. The index information receiving unit accepts a TCP connection request from the data management device, holds a TCP connection, and uses the held TCP connection to receive index information of data managed by the data management device. The index information transmitting unit transmits the index information to the client device. The client device includes an access request transmitting unit that transmits an access request for data, which is managed by the data management device, to the server device according to the index information. The server device also includes a data transmitting unit. When the server device receives an access request for data, which is managed by the data management device, from the client device, the data transmitting unit of the server device acquires designated data from the data management device using the held TCP connection, and transmits the acquired data to the client device.

According to another aspect of the present invention, the communication system also includes an authentication unit that authenticates an access request made by the client device.

According to another aspect of the present invention, the communication system also includes an index information receiving unit, a setting unit, and an index information transmitting unit. The index information receiving unit holds a TCP connection with a plurality of data management devices, and receives index information from the plurality of the data management devices. The setting unit sets an access right of the client device with respect to each of the data management devices or a group of data management devices. The index information transmitting unit transmits index information of the data management device, of which the client device is given an access right, to the client device.

The server device of the present invention accepts a TCP connection request from the data management device, and holds a TCP connection. When receiving an access request from the client device, the server device acquires data from the data management device using the held TCP connection, and transmits the data to the client device. Since the server device is not required to carry out a TCP connection request to the data management device, the data management device can be provided in a highly-secure network. A location of the data management device and a location of data may be concealed with respect to the client device. As a result, the security level can be maintained high. In order to reject an access to data, the data management device can just disconnect the TCP connection. Accordingly, the data management device can easily restrict an access at emergency. Since a TCP connection is held between the server device and the data management device, failure in the data management device can be detected promptly. Therefore, abnormality is no longer noticed after attempting and failing to establish a connection when an access to the data management device generates as in a conventional communication system.

The server device of the present invention includes an authentication unit that authenticates an access request made by the client device. Therefore, the data management device is not required to include an authentication unit. When there are a plurality of data management devices, the server device can uniformly manage authentication information.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an overall schematic view of a communication system according to a preferred embodiment of the present invention.

FIG. 2 is a block diagram of a data management device and a gateway file server.

FIG. 3 illustrates contents of records of index information.

FIG. 4 illustrates an example of registration of a database in the data management device.

FIG. 5 illustrates an example of registration of a database in a client device.

FIG. 6 illustrates an example of registration of an access right.

FIG. 7 illustrates an example of registration of an access log DataBase (DB).

FIG. 8 is a flowchart illustrating a processing carried out in the entire communication system.

FIG. 9 illustrates an example of a user interface displayed on a monitor of the client device.

FIG. 10 illustrates an example of a user interface displayed on a monitor of the client device.

FIG. 11A through FIG. 11C are flowcharts illustrating a processing carried out by the gateway file server when being accessed by the data management device.

FIG. 12 is a flowchart illustrating a processing carried out by the gateway file server when being accessed by the client device.

FIG. 13 is a flowchart illustrating a processing carried out by the gateway file server when accepting an index information reception request from the client device.

FIG. 14 is a flowchart illustrating a processing carried out by the gateway file server when accepting a file access request from the client device.

FIG. 15 is a flowchart illustrating a processing carried out by the gateway file server when accessing a file writing request from the client device.

### DETAILED DESCRIPTION OF PREFERRED EMBODIMENTS

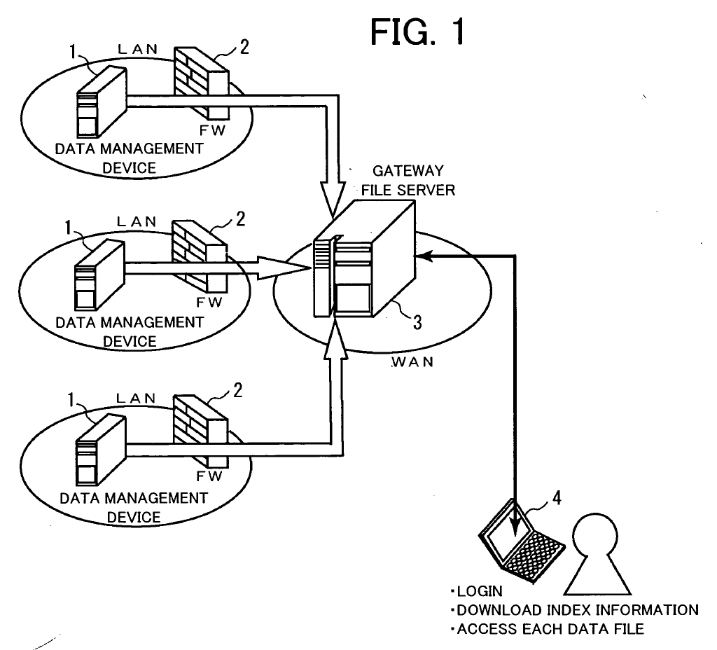

In the following, a description will be made of preferred embodiments of the present invention with reference to the drawings. FIG. 1 is an overall schematic view of a communication system according to a preferred embodiment of the present invention. The communication system includes a data management device 1 provided in a LAN, a gateway file server 3 provided in a Wide Area Network (WAN), and a client device 4. As illustrated in FIG. 1, a plurality of LANs are connected to the WAN, and the data management device 1 is provided in each of the LANs. A plurality of data management devices 1 may be connected to one LAN.

The LAN is a private network, and a firewall (FW) 2 is provided between the LAN and the WAN. Therefore, an access to a computer in the LAN from the WAN is restricted. The client device 4 is a terminal used by a user. The user uses the client device 4 to refer to data stored in the data management device 1, or to carry out an update processing of data with respect to the data management device 1. The client device 4 is connected directly or via another network to the WAN.

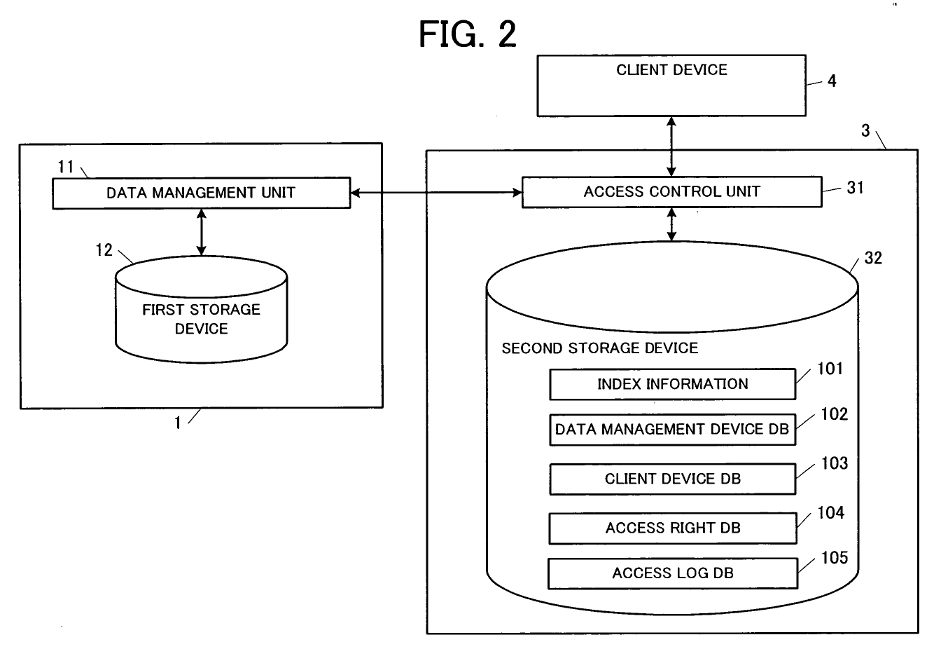

FIG. 2 is a block diagram of the data management device 1 and the gateway file server 3. The data management device 1 includes a data management unit 11, and a first storage device 12. The data management unit 11 is a functional unit realized by a program stored in the data management device 1 being executed using hardware resources such as a Central Processing Unit (CPU) and a Random Access Memory (RAM). The data management unit 11 includes a function for transmitting and receiving index information and data stored in the first storage device 12 to and from the gateway file server 3.

The gateway file server 3 includes an access control unit 31, and a second storage device 32. The access control unit 31 is a functional unit realized by a program stored in the gateway file server 3 being executed using hardware resources such as a CPU and a RAM. The second storage device 32 includes index information 101, a data management device database (database will hereinafter be referred to as “DB”) 102, a client device DB 103, an access right DB 104, and an access log DB 105.

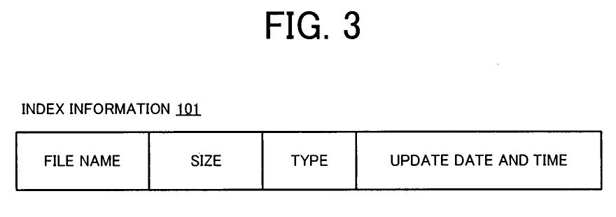

The index information 101 is information acquired from the data management device 1. An index of data stored in the first storage device 12 of the data management device 1 is recorded in the index information 101. By providing the index information 101 to the client device 4, the user can learn what kind of data is stored in the data management device 1. FIG. 3 illustrates an example of a chart of contents of records of the index information 101.

As illustrated in FIG. 3, the index information 101 includes “file name”, “file size”, “file type”, and “update date and time of file” for each data. The gateway file server 3 stores the index information 101 of a plurality of data management devices 1 in the second storage device 32. For example, as illustrated in FIG. 1, in case of a system using data stored in three data management device 1, the gateway file server 3 stores the index information 101 of all of the three data management devices 1.

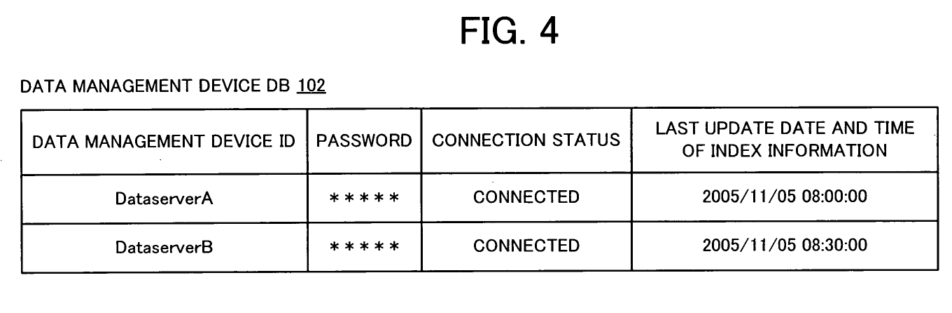

The data management device DB 102 is a database of the data management devices 1 that can be used in the communication system. FIG. 4 illustrates an example of registration of the data management device DB 102. Specifically, FIG. 4 illustrates an example of registration of two data management devices 1 (“DataserverA” and “DataserverB”).

In FIG. 4, “data management device ID” is a field storing an ID for identifying each of a plurality of the data management devices 1. “Password” is a field storing a password for each data management device 1 to login to the gateway file server 3. “Connection status” is a field for registering whether or not a TCP connection between each data management device 1 and the gateway file server 3 is currently held. “Last update date and time of index information” is a field storing information of date and time when the data management device 1 transmitted the index information to the gateway file server 3 most recently.

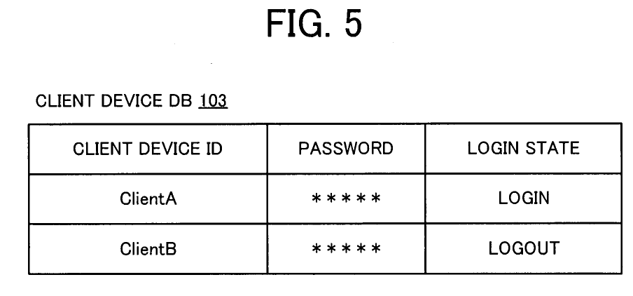

The client device DB 103 is a database of the client device 4 using the communication system. FIG. 5 is a chart illustrating an example of registration of two client devices 4 (“ClientA” and “ClientB”).

In FIG. 5, “client device ID” is a field storing an ID for identifying each of a plurality of the client devices 4. “Password” is a field for storing a password used by each of the client devices 4 to log into the gateway file server 3. “Login state” is a field for setting whether or not each of the client devices 4 is currently logged in the gateway file server 3.

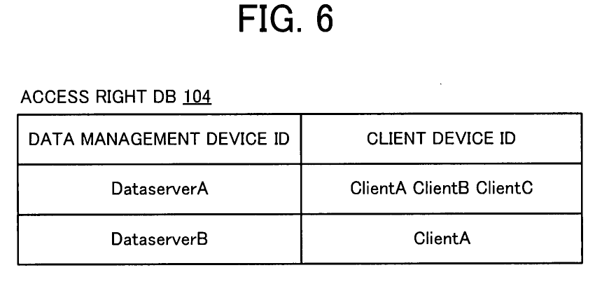

The access right DB 104 is a database for registering an access right of the client device 4 with respect to the data management device 1. In the communication system of the present preferred embodiment, although a plurality of the data management devices 1 provide data in a usable form, all of the client devices 4 are not uniformly permitted to access the data. An access right is managed in the access right DB 104. FIG. 6 illustrates an example of registration of the access right DB 104.

In FIG. 6, an access right relating to two data management devices 1 (“DataserverA” and “DataserverB”) is registered. That is, ClientA, ClientB, and ClientC are permitted to access the DataserverA, and only the ClientA is permitted to access the DataserverB. Further, as illustrated in FIG. 6, other than setting an access right for an individual data management device 1, an access restriction may be set for a group of data management devices 1. For example, a common access restriction may be conveniently set for a plurality of data management devices 1 located within the same LAN. In such a case, a group ID may be set for a data management device ID.

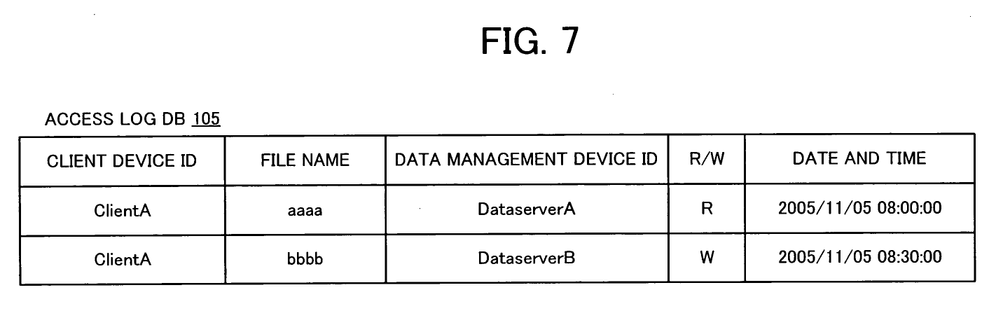

The access log DB 105 is a database storing a log of when the client device 4 accessed the data stored in the data management device 1. FIG. 7 illustrates an example of registration of the access log DB 105. For example, the access log DB 105 stores a log (R) indicating that the ClientA has retrieved a file “aaa” stored in the “DataserverA” at 8:00 on Nov. 5, 2005. Alternatively, the access log DB 105 stores a log (W) indicating that the ClientB has wrote a file “bbb” into the “DataserverB” at 8:30 on Nov. 5, 2005.

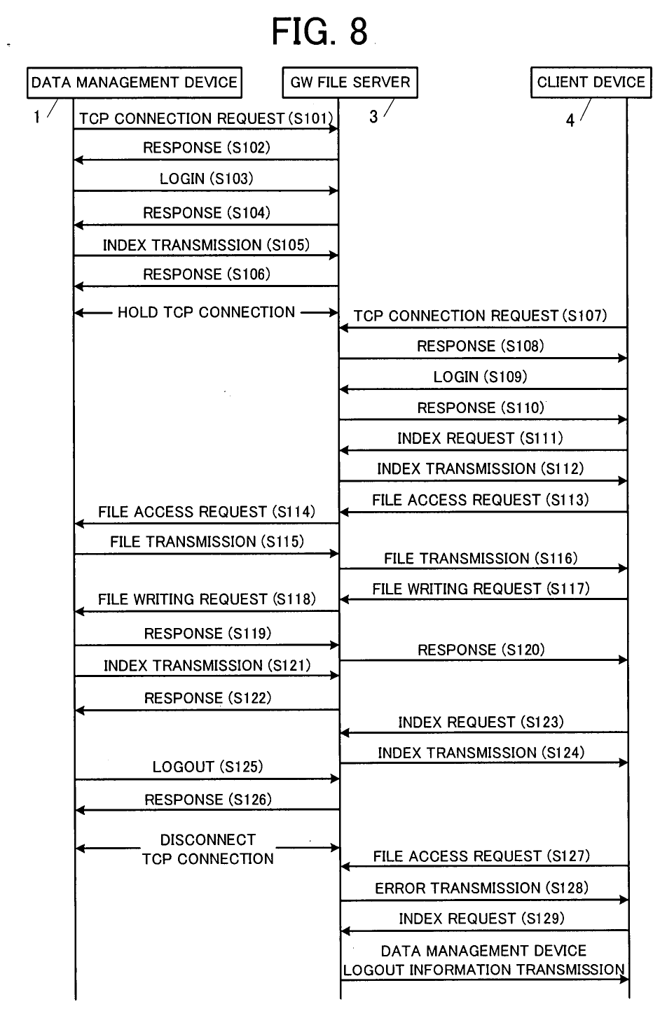

With reference to flowcharts of FIG. 8 and FIG. 11A through FIG. 14, a description will be made of a flow of a processing of a communication system using the data management device 1 and the gateway file server 3. Further, the processing executed in each of the flowcharts is a processing executed by the data management unit 11 for the data management device 1 and a processing executed by the access control unit 31 for the gateway file server 3.

FIG. 8 illustrates a flow of a processing carried out between the data management device 1, the gateway file server 3, and the client device 4. Further, in the following description, the gateway file server 3 will be referred to as the server 3.

First, the data management device 1 carries out a TCP connection request to the server 3 (step S101). This TCP connection request is transmitted from an inner side (the LAN side) towards an outer side (the WAN side) with respect to the firewall. Therefore, it is not necessary to carry out a port setting that lowers security level.

When receiving a response from the server 3 (step S102), a TCP connection is established between the data management device and the server 3. Next, the data management device 1 transmits a login request (step S103). The login request includes password information. When the server 3 receives the login request, the server 3 refers to the data management device DB 102 for authenticating the password. When the password is successfully authenticated, the server 3 responds (step S104).

When receiving an authentication, the data management device 1 transmits the index information 101 to the server 3 (step S105). The index information 101 includes an index of data stored in the data management device 1. When receiving the index information 101, the server 3 stores the received index information 101 in the second storage device 32. Then, the server 3 carries out a response to notify the data management device 1 that registration of the index information 101 has been completed (step S106).

The index information 101 of the data stored in the data management device 1 is stored in the second storage device 32 of the server 3 as described above. Even after the transmission of the index information 101 is completed, the data management device 1 holds the TCP connection with the server 3. That is, a TCP connection is established between the data management device 1 and the server 3, index information is transmitted from the data management device 1 to the server 3, and the established TCP connection is held.

Next, the client device 4 carries out a TCP connection request to the server 3 (step S107). The server 3 is a server connected to the WAN, and is located outside of the firewall. Therefore, the client device 4 can access the server 3.

When the server 3 responds to the TCP connection request (step S108), a TCP connection request is established between the client device 4 and the serer 3. Next, the client device 4 transmits a login request (step S109). The login request includes password information. The server 3 refers to the client device DB 103 to authenticate the password. When the password is successfully authenticated, the server 3 responds to the client device 4 (step S110).

When the login results a success, the client device 4 transmits an index request to the server 3 (step S111). The server 3 transmits the index information 101 stored in the second storage device 32 to the client device 4 (step S112). Further, the server 3 refers to the access right DB 104, and transmits only the index information 101 of the data management device 1 for which the client device 4 has an access right (or the data management device 1 belonging to a group for which the client device 4 has an access right).

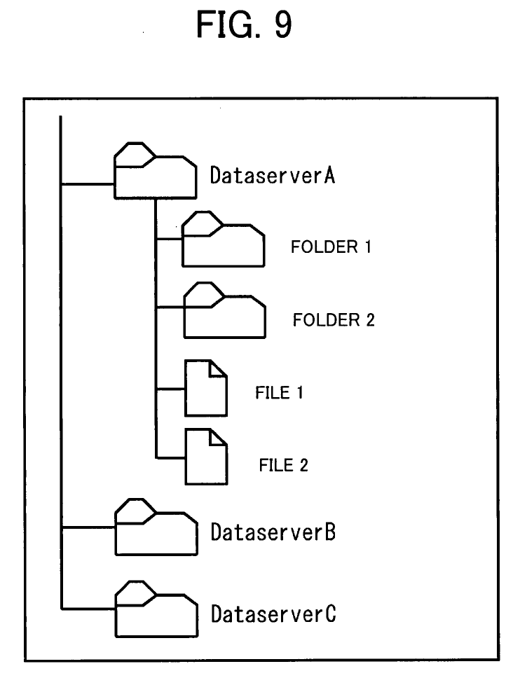

When the client device 4 receives the index information 101 as described above, a user interface generated according to the index information 101 is displayed on a monitor of the client device 4 as illustrated in FIG. 9. In an example illustrated in FIG. 9, the client device 4 has received the index information 101 of three data management devices 1, i.e., DataserverA, DataserverB, and DataserverC, and the monitor of the client device 4 displays information of data stored in each of the data management devices 1. For example, when the data is managed by folders as illustrated in FIG. 9, the displayed user interface would be convenient for a user if the folders are displayed hierarchically. In the example illustrated in FIG. 9, a folder of the DataserverA is selected, and folders and files included in the selected folder are displayed.

The user refers to the user interface as illustrated in FIG. 9, and selects a file to be accessed. In response to such an operation, the client device 4 carries out a file access request to the server 3 (step S113). When receiving the file access request, the server 3 forwards the file access request to the data management device 1 (step S114). Further, in this case, the TCP connection held between the server 3 and the data management device 1 (TCP connection established at steps S101 and S102) is used.

When receiving an access request, the data management device 1 transmits a corresponding file to the server 3 (step S115). The server 3 forwards the file received from the data management device 1 to the client device 4 (step S116). The client device 4 can access a desired file as described above.

When a change is made to the received file by the client device 4, the client device 4 transmits a file writing request to the server 3 (step S117). The server 3 uses the held TCP connection to forward the file writing request to the data management device 1 (step S118).

After the writing of the file is completed, the data management device 1 responds to the server 3 (step S119). The server 3 responds to the client device 4 that the writing has been completed (step S120).

When the writing processing of the file is executed, information of data stored in the data management device 1 is changed. Therefore, the data management device 1 transmits the index information 101 to the server 3 again (step S121). The server 3 updates the index information 101, and responds to the data management device 1 (step S122).

Then, at any timing (preferably, periodically), when the client device 4 carries out an index request again (step S123), the server 3 transmits the updated index information 101 to the client device 4 (step S124). As described above, latest index information 101 is provided to the client device 4.

At any timing, the data management device 1 carries out a logout request to the server 3 (step S125). The server 3 executes a logout processing, and responds to the data management device 1 (step S126). Accordingly, the TCP connection between the data management device 1 and the server 3 is disconnected.

At this time, the user interface as illustrated in FIG. 9 is still displayed on the monitor of the client device 4. The client device 4 may transmit a file access request to the server 3 again (step S127). Suppose that requested file is a file stored in the data management device 1 that has logged out at step S125. In such a case, the server 3 carries out an error transmission to the client device 4 (step S128). That is, the server 3 carries out a notification that an access is impossible.

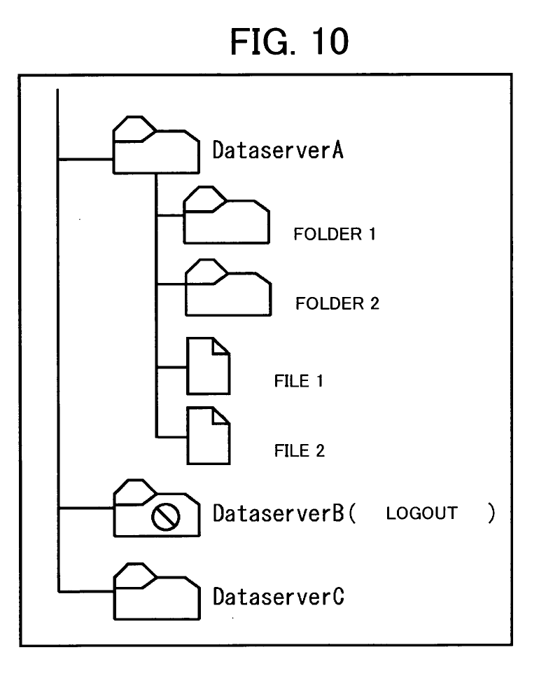

Accordingly, the client device 4 carries out an index request to the server 3 again (step S129). The server 3 transmits logout information of the data management device 1 to the client device 4 (step S130). Alternatively, the server 3 transmits the latest index information 101 excluding the index information 101 of the data management device 1 that has logged out. Accordingly, a user interface as illustrated in FIG. 10 is displayed on the monitor of the client device 4. For example, in an example illustrated in FIG. 10, the user interface displays that the DataserverB has logged out and is currently inaccessible.

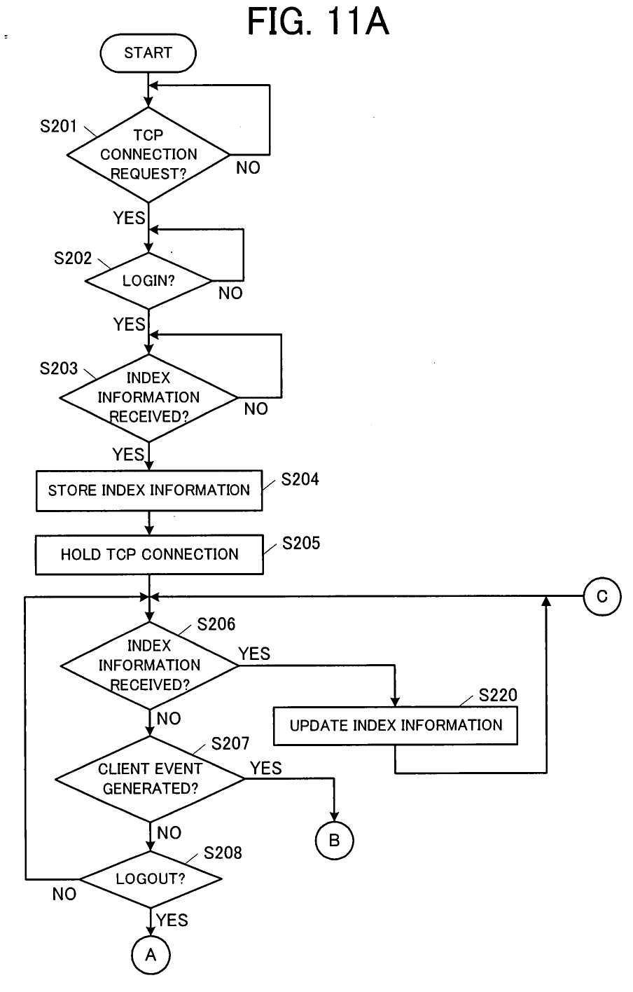

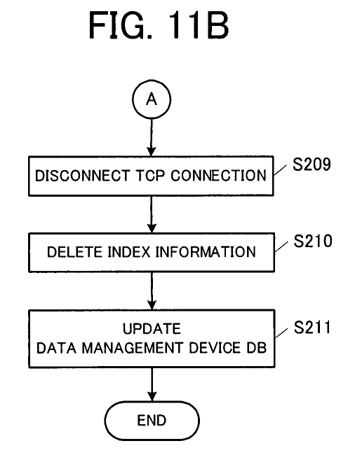

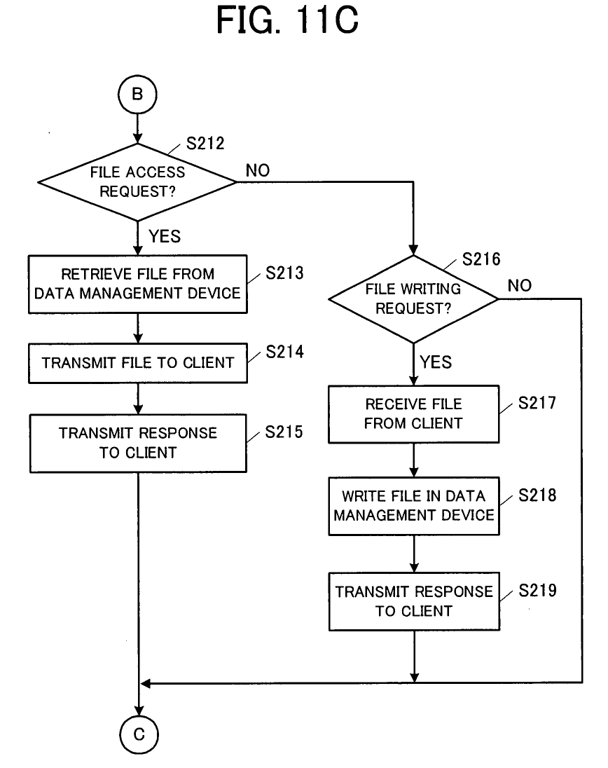

The processing method of the communication system according to the present preferred embodiment has been described as a flow of processing of the entire system including the data management device 1, the server 3, and the client device 4. Next, with reference to FIG. 11A through FIG. 14, a description will be made primarily of the processing of the server 3.

FIG. 11A through FIG. 11C are flowcharts illustrating a processing carried out by the server 3 after accepting a connection request from the data management device 1. The server 3 monitors a TCP connection request from the data management device 1 (step S201). When accepting a TCP connection request, the server 3 establishes a TCP connection with the data management device 1. Next, the server 3 monitors a login request (step S202). When receiving a login request, the server 3 authenticates a password. The authentication of the password is carried out by referring to the data management device DB 102. When the password matches, the server 3 permits login.

Next, the server 3 stands by until receiving the index information 101 from the data management device 1 (step S203). When receiving the index information 101, the server 3 stores the received index information 101 in the second storage device 32 (step S204). After receiving the index information 101, the server 3 holds the TCP connection (step S205).

Next, the server 3 determines whether or not the index information 101 has been received again (step S206). When receiving the index information 101 again, the server 3 updates the index information 101 (step S220). When continually receiving the index information 101, the server 3 repeats step S220.

When the index information 101 is not received, the server 3 confirms as to whether or not an event of the client device 4 has generated (step S207). When an event has not generated, the server 3 confirms as to whether or not a logout request from the data management device 1 has generated (step S208). When the logout request has generated, the server 3 disconnects the TCP connection (step S209), and deletes the index information 101 relating to data management device 1 that has logged out (step S210). Then, the server 3 updates registered contents of the data management device DB 102 (step S211). Specifically, the server 3 registers information “disconnected” in the “connection status” field.

When a determination is made at step S207 that an event has generated at the client, the server 3 determines as to whether or not a file access request has generated (step S212). When a file access request has generated, the server 3 acquires a corresponding file from the data management device 1 (step S213), and transmits the corresponding file to the client device 4 (step S214). After transmitting the file, the server 3 transmits a response indicating that the file access has been completed (step S215).

When a file access request is not received at step S212, the server 3 determines as to whether or not a file writing request has generated (step S216). When a file writing request has generated, the server 3 receives a file from the client device 4 (step S217), and transmits the file and carries out a file writing request to the data management device 1 (step S218). When the file writing with respect to the data management device 1 is completed, the server 3 carries out a response to the client device 4 to notify that the file writing has been completed (step S219). When a determination is made at step S216 that a file writing request has not generated, a different event may be generating and a processing according to such an event is executed. However, a description will be omitted.

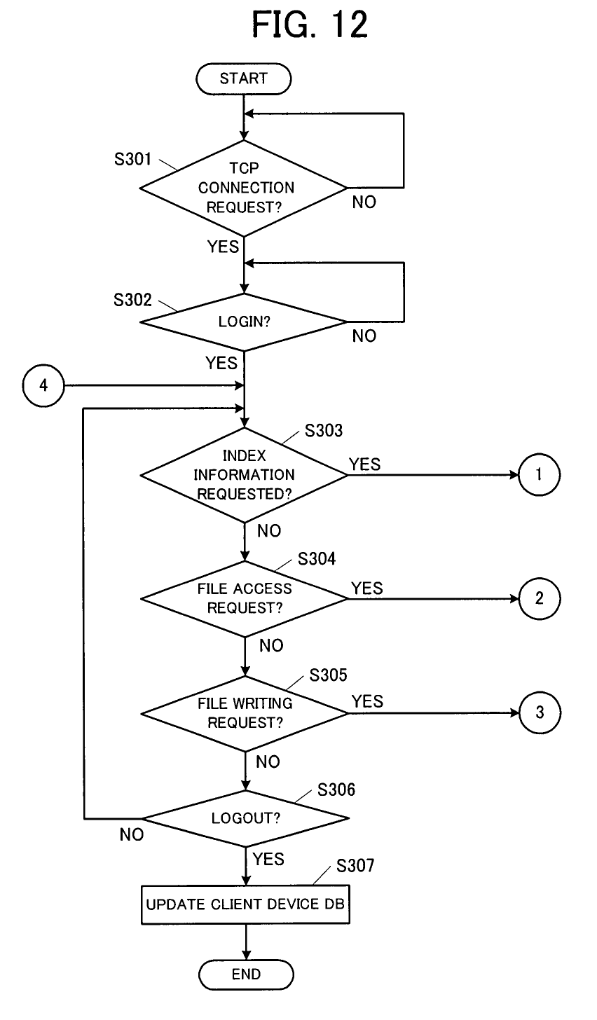

FIG. 12 is a flowchart illustrating a processing carried out by the server 3 after accepting a connection request from the client device 4.

First, the server 3 monitors a TCP connection request from the client device 4 (step S301). When receiving a TCP connection request, the server 3 establishes a TCP connection, and monitors a login request (step S302).

When receiving a login request, the server 3 refers to the client device DB 103, and authenticates a password. When the password matches, the server 3 permits the client device 4 to login. Since the server 3 carries out the authentication of the user, each of the data management devices 1 is not required to carry out an authentication processing. Next, the server 3 determines as to whether or not a reception request of the index information 101 has been received from the client device 4 (step S303).

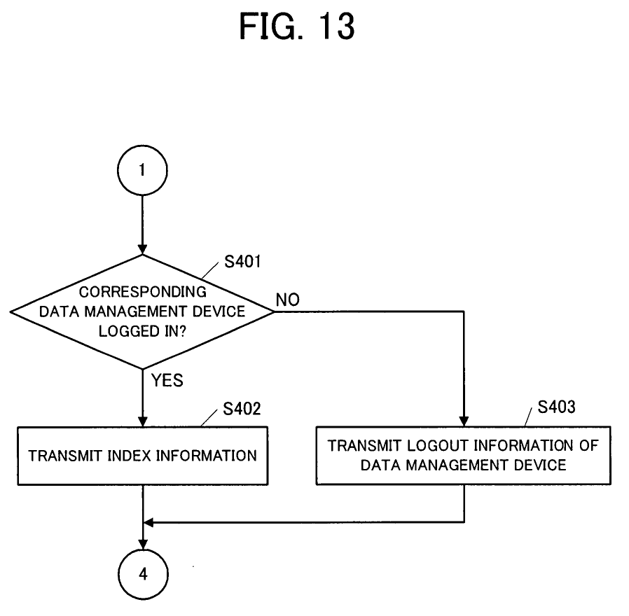

When a reception request of the index information 101 is generated, the process proceeds onto the flowchart of FIG. 13. First, the server 3 confirms as to whether or not the data management device 1 of which the client device 4 wishes to acquire the index information 101 is currently logged in (step S401). That is, the server 3 confirms as to whether or not the data management device 1 of which the client device 4 has an access right is logged in. Specifically, the server 3 refers to the data management device DB 102, and confirms as to whether or not “connected” is registered in the “connection status” field.

When the corresponding data management device 1 is not connected, the server 3 transmits information to the client device 4 indicating that the data management device 1 is logged out (step S403). When the corresponding data management device 1 is connected, the server 3 transmits the index information 101 relating to the corresponding data management device 1 to the client device 4 (step S402).

When the above processing is completed, the processing returns to step S303 of FIG. 12 again, and the processing is repeated.

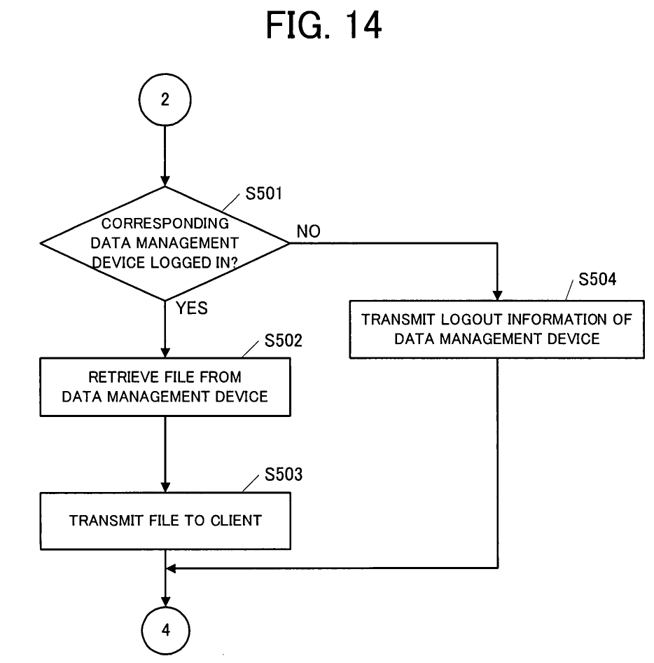

When a reception request of the index information 101 has not generated at step S303, the server 3 confirms as to whether or not a file access request has generated (step S304). When the file access request has generated, the process proceeds onto the flowchart of FIG. 14. First, the server 3 confirms as to whether or not the data management device 1 storing a file, which the client device 4 wishes to access, is currently logged in (step S501). That is, the server 3 refers to the data management device DB 102, and confirms as to whether or not “connected” is stored in the “connection status” field.

When the corresponding data management device 1 is not connected, the server 3 transmits information indicating that the corresponding data management device 1 is logged out to the client device 4 (step S504). When the corresponding data management device 1 is connected, the server 3 retrieves the designated file from the corresponding data management device 1 (step S502), and transmits the retrieved file to the client device 4 (step S503).

When the above processing is completed, the processing returns to step S303 of FIG. 12 again, and the processing is repeated.

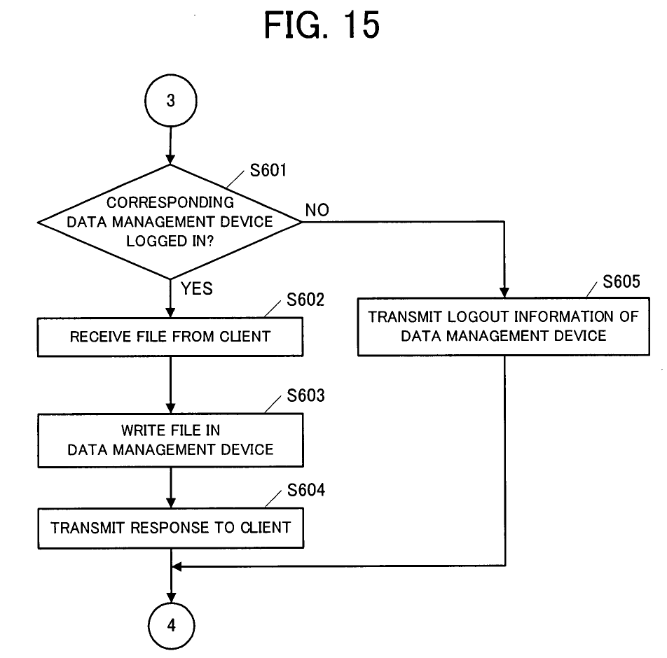

When the file access request has not generated at step S304, the server 3 determines as to whether or not a file writing request has generated (step S305). When the file writing request has generated, the process proceeds onto the flowchart of FIG. 15. First, the server 3 confirms as to whether or not the data management device 1 of which the client device 4 wishes to write the file is currently logged in (step S601). That is, the server 3 refers to the data management device DB 102, and confirms as to whether or not “connected” is registered in the “connection status” field.

When the corresponding data management device 1 is not connected, the server 3 transmits information to the client device 4 indicating that the corresponding data management device 1 is logged out (step S605). When the corresponding data management device 1 is connected, the server 3 receives a writing file from the client device 4 (step S602). The server 3 transmits the received file to the data management device 4, and executes a writing processing (step S603). When the writing processing is completed, the server 3 carries out a response to the client device 4 that the writing has been completed (step S604).

When the above processing is completed, the processing returns to step S303 of FIG. 12 again, and the processing is repeated.

When the file writing request has not generated at step S305, the server 3 confirms as to whether or not a logout request from the client device 4 is generated (step S306). When the logout request has not generated, the processing returns to step S303, and the processing is repeated. When the logout request has generated, the server 3 executes the logout processing, and updates information of the client device DB 103 (step S307). Specifically, the server 3 sets “logout” in the “login status” field.

As described above, by using the communication system or the gateway file server 3 according to the present preferred embodiment, while maintaining security of the data management device 1 or the private network in which the data management device 1 is provided, the client device 4 can access the data stored in the data management device 1. Specifically, without carrying out a setting to permit a TCP connection from outside at the firewall 2, the data stored in the data management device 1 can be provided accessible.

That is, a TCP connection request is carried out from the data management device 1 located inside the firewall 2 to the gateway file server 3, and a TCP connection is established. Then, the established TCP connection is held. When a file access request or a file writing request generates from the client device 4, the gateway file server 3 uses the held TCP connection to access the data management device 1. Accordingly, it is possible to prevent a security hole from generating in the firewall.

A location (address) of the data management device 1 is not notified to the client device 4, and the client device 4 just refers to the index information 101 and accesses the gateway file server 3. Therefore, it is possible to conceal the location (address) of the data management device 1, and a storage location of actual data. As a result, high security level can be maintained.

The client device 4 is just required to store setting information for accessing the gateway file server 3. Therefore, even when an address of the data management device 1 is changed, the setting in the client device 4 is not required to be changed. As a result, the client device 4 can flexibly respond to a change of the system.

The authentication of the client device 4 (user) is carried out by the gateway file server 3. Therefore, an authentication processing is not required to be carried out in each data management device 1, and authentication information can also be managed uniformly in the server 3. For example, even when the information of the client device 4 is changed, it is just necessary to change the client device DB 103 stored in the gateway file server 3. As a result, management load of the data management device 1 can be reduced.

The data management device 1 can immediately shut an access from the client device 4 just by disconnecting the TCP connection established between the data management device 1 and the gateway file server 3. Therefore, an urgent access control can also be executed easily. When the data management device 1 appears to be not accessible to the client device 4, the client device 4 can access the gateway file server 3 and learn that the data management device 1 is not accessible. As a result, it is convenient for users of the client device 4. For example, the present preferred embodiment solves a problem that a response is not returned when accessing an inaccessible data server (there are cases in which an application hangs up).

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A server device comprising:
means for accepting a transmission control protocol connection request from a data management device, holding a transmission control protocol connection, and receiving index information of data managed by the data management device using the held transmission control protocol connection;
means for transmitting the index information to a client device; and
means for acquiring, when receiving an access request from the client device according to the index information for accessing the data managed by the data management device, designated data from the data management device through the held transmission control protocol connection and transmitting the acquired data to the client device.

2. The server device according to claim 1, further comprising means for authenticating the access request of the client device.

3. The server device according to claim 1, further comprising:
means for holding a transmission control protocol connection with a plurality of data management devices and receiving index information from the plurality of the data management devices;
means for setting an access right of the client device for each of the data management devices; and
means for transmitting the index information of at least one of the data management devices, for which the access right is given, to the client device.

4. The server device according to claim 1, further comprising:
means for holding a transmission control protocol connection with a plurality of data management devices and receiving index information from the plurality of the data management devices;
means for setting an access right of the client device for a group of the data management devices; and
means for transmitting the index information of the data management devices, for which the access right is given, to the client device.

5. The server device according to claim 2, further comprising:
means for holding a transmission control protocol connection with a plurality of data management devices and receiving index information from the plurality of the data management devices;
means for setting an access right of the client device for each of the data management devices; and
means for transmitting the index information of at least one of the data management devices, for which the access right is given, to the client device.

6. The server device according to claim 2, further comprising:
means for holding a transmission control protocol connection with a plurality of data management devices and receiving index information from the plurality of the data management devices;
means for setting an access right of the client device for a group of the data management devices; and
means for transmitting the index information of the data management devices, for which the access right is given, to the client device.

7. A communication system comprising a data management device, a server device, and a client device,
wherein the data management device including:
means for storing and managing data; and
means for requesting a transmission control protocol connection to a server device;
the server device including:
means for accepting a transmission control protocol connection request from the data management device, holding a transmission control protocol connection, and receiving index information of data managed by the data management device using the held transmission control protocol connection; and
means for transmitting the index information to the client device,
the client device including means for transmitting an access request for the data managed by the data management device according to the index information to the server device,
wherein the server device further includes means for acquiring, when receiving an access request from the client device for accessing the data managed by the data management device, designated data from the data management device through the held transmission control protocol connection and transmitting the acquired data to the client device.

8. The communication system according to claim 7, wherein the server device includes means for authenticating an access request of the client device.

9. The communication system according to claim 7, wherein the server device further including:
means for holding a transmission control protocol connection with a plurality of data management devices and receiving index information from the plurality of the data management devices;
means for setting an access right of the client device for each of the data management devices; and
means for transmitting the index information of at least one of the data management devices, for which the access right is given, to the client device.

10. The communication system according to claim 8, wherein the server device further including:
means for holding a transmission control protocol connection with a plurality of data management devices and receiving index information from the plurality of the data management devices;
means for setting an access right of the client device for each of the data management devices; and
means for transmitting the index information of the data management devices, for which the access right is given, to the client device.

11. The communication system according to claim 7, wherein the server device further including:
means for holding a transmission control protocol connection with a plurality of data management devices and receiving index information from the plurality of the data management devices;
means for setting an access right of the client device for a group of the data management devices; and
means for transmitting the index information of the data management devices, for which the access right is given, to the client device.

12. The communication system according to claim 8, wherein the server device further including:
means for holding a transmission control protocol connection with a plurality of data management devices and receiving index information from the plurality of the data management devices;
means for setting an access right of the client device for a group of the data management devices; and
means for transmitting the index information of the data management devices, for which the access right is given, to the client device.
